(19) United States
(12) Patent Application Publication
(10) Pub. No.: US 2026/0260159 A1
(43) Pub. Date: Sep. 3, 2026

(54) FINE-TUNING TRAINING DATA TO IMPROVE MODEL PERFORMANCE USING ENSEMBLE LEARNING

(71) Applicant: Dell Products L.P., Round Rock, TX (US)

(72) Inventors: Akash Kumar Gupta, Bengaluru (IN); Abhishek Mishra, Bangalore (IN); Shalini Tiwari, Bangalore (IN)

(21) Appl. No.: 19/067,280

(22) Filed: Feb. 28, 2025

(51) Int. Cl. G06N 20/00; G06F 18/213

(52) U.S. Cl. CPC G06N 20/00; G06F 18/213

(57) ABSTRACT

A method for fine-tuning a training dataset includes calculating a set of SHAP values of each qualified machine learning (ML) model in a list of qualified ML models to obtain multiple sets of SHAP values. The method also includes aggregating the multiple sets of SHAP values to obtain a set of aggregated SHAP values and setting a static threshold and a high relative threshold. Moreover, the method includes identifying a first subset of aggregated SHAP values from the set of aggregated SHAP values that exceed the high relative threshold. Further, the method includes extracting a first set of features corresponding to the first subset of aggregated SHAP values to obtain a set of relevant features. Also, the method includes adding, to the training dataset, relevant features from the first set of relevant features that are not present in the training dataset to obtain a fine-tuned training dataset.

### BACKGROUND

Ensemble learning allows machine learning (ML) models to improve their accuracy by leveraging strengths of multiple ML models. However, traditional ensemble learning techniques fail to address model-specific confidence and feature importance in a dynamic manner.

### BRIEF DESCRIPTION OF DRAWINGS

Certain embodiments of the disclosure will be described with reference to the accompanying drawings. However, the accompanying drawings illustrate only certain aspects or implementations of the disclosure by way of example and are not meant to limit the scope of the claims.

FIG. 1 shows a diagram of a system in accordance with one or more embodiments of the invention.

FIG. 2 shows a flowchart of a method for obtaining a list of qualified ML models in accordance with one or more embodiments of the invention.

FIG. 3 shows a flowchart of a method for fine-tuning a training dataset in accordance with one or more embodiments of the invention.

FIG. 4 shows a flowchart of a method for monitoring the performance of the qualified ML models in accordance with one or more embodiments of the invention.

FIG. 5 shows a computing system in accordance with one or more embodiments of the invention.

### DETAILED DESCRIPTION

In the rapidly evolving landscape of machine learning (ML) and artificial intelligence (AI), ensemble learning has become a common strategy for achieving superior predictive performance. Ensemble learning is an ML technique that leverages the strengths of multiple ML models by aggregating the predictions of the multiple ML models to improve accuracy.

However, traditional ensemble learning techniques often fall short in addressing model-specific confidence and feature importance in a dynamic manner. Additionally, current approaches to ensemble learning do not fully utilize the potential of feature importance metrics, such as Shapley Additive Explanations (SHAP) values, for model improvement. Further, fine-tuning individual ML models based on their strengths and weaknesses requires a deep understanding of how different features influence the model's predictions. This level of understanding is often lacking in current methodologies. Moreover, the ML models in traditional ensemble approaches work in tandem, contributing to a combined output without direct competition or individual model feedback.

The limitations of the traditional approaches to ensemble learning restricts the usability and potential improvement of ML models. For at least the reasons discussed above, a fundamentally different approach is needed to address these challenges. Embodiments of the invention relate to a method for fine-tuning a training dataset. As a result of the processes discussed below, one or more embodiments disclosed herein introduce a unified system that not only integrates multiple ML models, but also utilizes SHAP values to refine the training dataset and improve overall performance and accuracy. Further, the training dataset is dynamically refined based on feature importance. Embodiments of the invention continuously re-trains the ML models based on these insights, fostering a competitive environment that enables continuous improvement as the top-performing models are iteratively retrained and assessed. One or more embodiments disclosed herein advantageously ensure a significant advancement over traditional ensemble learning techniques by offering actionable recommendations for dataset fine-tuning.

There are numerous use cases for the invention disclosed herein. As a non-limiting example, consider a scenario in which a manufacturing company collects sensor data from machines to predict when they might fail. The dataset includes various sensor readings (such as temperature, vibration, pressure) over time. However, not all sensor features are relevant, and some may introduce noise. By leveraging one or more embodiment of the invention, the system can become more efficient in predicting equipment failures by reducing false positives and improving predictive accuracy. Additional relevant features (such as operating conditions or maintenance schedules) may also be added to enhance the model's performance.

As another non-limiting example, consider a scenario in which a hospital uses a ML model to predict patient readmission within 30 days of discharge. By leveraging one or more embodiments of the invention, the hospital can identify key features (such as age, previous readmission history, length of stay, etc.) as the most important predictors for readmission. Based on these important features, the hospital can add relevant features (such as comorbidities, discharge compliance, social support, etc.) to improve the machine learning model's accuracy. These additional features provide a more holistic view of patient health, assisting the model to better account for the factors driving patient readmissions. Further, embodiments of the inventions implement continuous monitoring in order to ensure that the ML model's performance is not degrading over time. For example, consider a scenario in which the ML model was initially tuned using a data set corresponding to patients in a first geographic area; if the hospital subsequently changes its geographic location where the patients have a different set of demographics as compared to the patients at the first geographic location, then embodiments of the invention would detect a degradation in performance of the ML model. In response to this detection, embodiments of the invention would trigger the generation of a new training dataset that would more accurately reflect the surrounding population in the second geographic location.

Specific embodiments will now be described with reference to the accompanying figures.

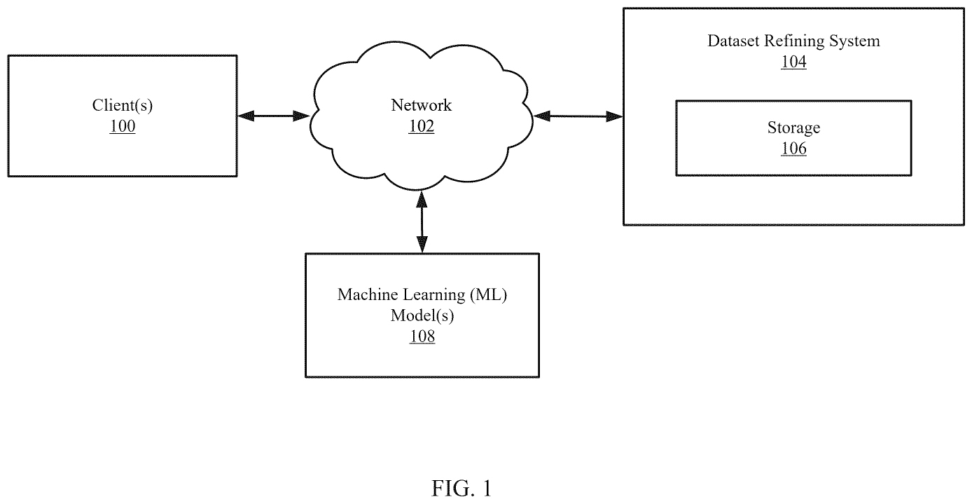

FIG. 1 shows a system in accordance with one or more embodiments of the invention. The system may include any number of clients (100), a network (102), a dataset refining system (104), a storage (106) and any number of machine learning (ML) models (108). The system may include additional, fewer, and/or different components without departing from the scope of the invention. Each component may be operably/operatively connected to any of the other components via any combination of wired and/or wireless connections. Each of these system components is described below.

In one or more embodiments, the client(s) (100) and the dataset refining system (104) may be operatively connected to one another through a network (102) (e.g., a local area network (LAN), a wide area network (WAN) such as the Internet, a mobile network, any other network type, or a combination thereof). The network (102) may be implemented using any combination of wired and/or wireless connections. Further, the network (102) may encompass various interconnected, network-enabled subcomponents (or systems) (e.g., switches, routers, gateways, etc.) that may facilitate communications between the client(s) (100) and the dataset refining system (104). Moreover, the client(s) (100) and the dataset refining system (104) may communicate with one another using any combination of wired and/or wireless communication protocols.

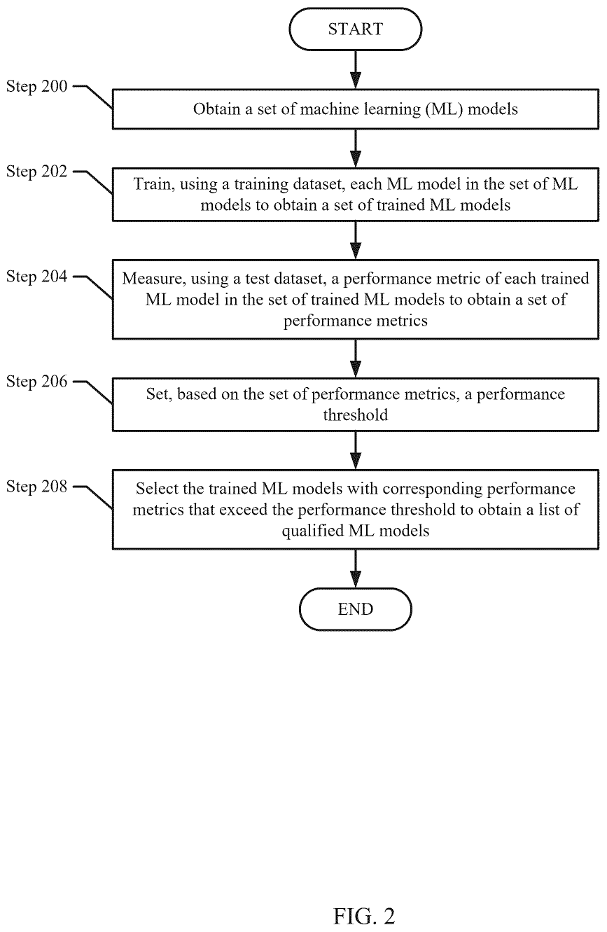

In one or more embodiments, the client(s) (100) includes functionality to permit users to interact with the dataset refining system (104). Further, the client(s) (100) includes functionality to perform at least a portion of the method shown in FIGS. 2-4. One of ordinary skill will appreciate that the client(s) (100) may perform other functionalities without departing from the scope of the invention.

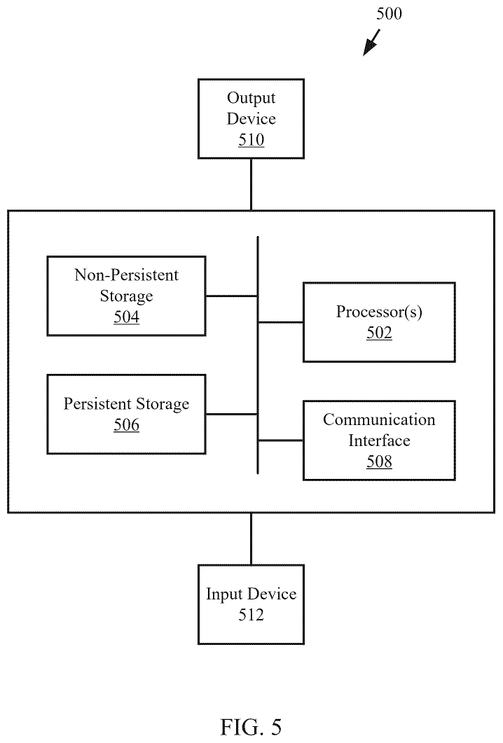

In one or more embodiments disclosed herein, the client(s) (100) may be a physical device or a virtual device (i.e., a virtual machine executing on one or more physical devices) such as a personal computing system (e.g., a laptop, a cell phone, a tablet computer, a virtual machine executing on a server, etc.) of a user. For example, the client(s) (100) may be a computing system (e.g., 500, FIG. 5) as discussed below in more detail in FIG. 5.

In one or more embodiments, the ML models (108) may be operatively connected to the network (102). In one or more embodiments, the ML models used to support the dataset refining system (104). In one or more embodiments, the dataset refining system (104) enhances ML model performance by leveraging the strengths of multiple ML models (108) and refining them through feature importance analysis by calculating their SHAP values. One of ordinary skill will appreciate that the ML models (108) may perform other functionalities without departing from the scope of the invention.

In one or more embodiments, the dataset refining system (104) includes functionality to select the top-performing ML models based on accuracy and SHAP analysis. In one or more embodiments, the dataset refining system (104) dynamically refines the model selection by using SHAP values to understand feature importance across the ML models. In one or more embodiments, the dataset refining system (104) also includes functionality to use the SHAP values to guide the dataset fine-tuning process rather than relying on static data adjustment methods. In the dataset fine-tuning process, features are added or removed based on their contribution to model predictions, ensuring that only the most relevant features are included. This tailored approach enhances the accuracy and reduces overfitting by considering specific feature interactions and contributions. In one or more embodiments, the dataset refining system (104) also includes functionality to integrate the SHAP value computation with feature importance analysis, dataset fine-tuning, and model retraining in a continuous loop. This process leverages SHAP values not only for model interpretability but for actively improving the model by adapting features and data preprocessing techniques based on SHAP-driven insights. In one or more embodiments, the dataset refining system (104) also includes functionality to utilize SHAP values to provide specific, actionable recommendations for dataset refinement. Combined with domain expertise, it identifies and adds potentially missing features that could enhance model performance. Unlike traditional ensemble methods, the dataset refining system (104) fosters competition between models by iterating on both accuracy and SHAP value insights. ML models are continuously re-evaluated based on performance and feature importance, with a feedback loop that incorporates new features and refined datasets. This adaptive process enables dynamic optimization and model selection. In one or more embodiments, the dataset refining system (104) includes functionality to perform at least a portion of the methods shown in FIGS. 2-4. One of ordinary skill will appreciate that the dataset refining system (104) may perform other functionalities without departing from the scope of the invention.

In one or more embodiments, the dataset refining system (104) may be a physical device or a virtual device (i.e., a virtual machine executing on one or more physical devices) such as a personal computing system (e.g., a laptop, a cell phone, a tablet computer, a virtual machine executing on a server, etc.) of a user. For example, the dataset refining system (104) may be implemented on a computing system (e.g., 500, FIG. 5) as discussed below in more detail in FIG. 5.

In one or embodiments, the dataset refining system (104) includes storage (106). In one or more embodiments, the storage (106) includes functionality to store training datasets and test datasets. The storage (106) may be volatile storage, non-volatile storage, or any combination thereof. Examples of a storage include (but are not limited to): a hard disk drive (HDD), a solid-state drive (SSD), random access memory (RAM), flash memory, a tap drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, and virtualized memory. One of ordinary skill will appreciate that the storage (106) may perform other functionalities without departing from the scope of the invention.

Turning to FIG. 2, FIG. 2 shows a flowchart of a method for obtaining a list of qualified machine learning (ML) models in accordance with one or more embodiments of the invention. The method may be performed by, for example, the dataset refining system (104, FIG. 1).

While the various steps in the flowchart shown in FIG. 2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 200, a set of ML models is obtained. In one or more embodiments, the set of ML models may be provided by a client(s) (100, FIG. 1). In one or more embodiments, the client(s) (100, FIG. 1) provides the set of ML models to the dataset refining system (104, FIG. 1).

In step 202, each ML model in the set of ML models is trained, using a training dataset, to obtain a set of trained ML models. In one or more embodiments, the training dataset is obtained from the storage (106, FIG. 1).

In step 204, a performance metric of each trained ML model in the set of trained ML models is measured, using a test dataset, to obtain a set of performance metrics. In one or more embodiments, a performance metric may include measuring the AUC or F1 metric of the trained ML models. AUC refers to the area under the curve, and F1 refers to the harmonic mean of precision and recall. Both of these metrics measure the accuracy of the trained ML model.

In step 206, a performance threshold is set based on the set of performance metrics. In one or more embodiments, the client(s) (100, FIG. 1) sets the performance threshold. In one or more embodiments, the performance threshold may be adjusted based on the use case.

In step 208, the trained ML models with corresponding performance metrics that exceed the performance threshold are selected to obtain a list of qualified ML models. In one or more embodiments, the list of qualified ML models are the top-performing models in the original set of ML models obtained in step 200.

The method may end following step 208.

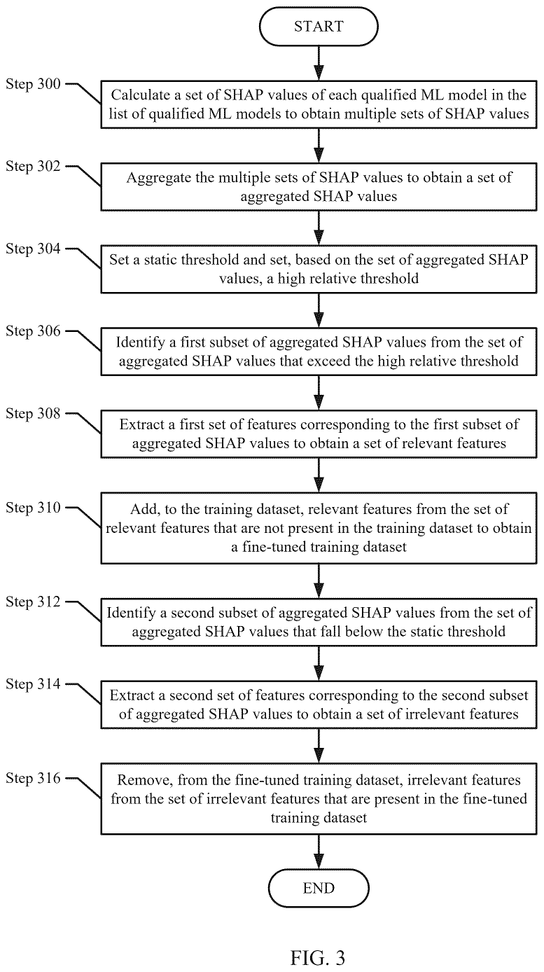

Turning to FIG. 3, FIG. 3 shows a method for fine-tuning a training dataset in accordance with one or more embodiments of the invention. The method may be performed by, for example, the dataset refining system (104, FIG. 1).

While the various steps in the flowchart shown in FIG. 3 are presented sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 300, a set of SHAP values of each qualified ML model in the list of qualified ML models are calculated to obtain multiple sets of SHAP values. In one or more embodiments, SHAP values measure how each feature contributes to the qualified ML model's prediction. Each feature is assigned an importance value representing its contribution the qualified ML model's output. This understanding is crucial to guiding feature selection, refinement, and dimensionality reduction. In one or more embodiments, the SHAP analysis may be visualized using global explanations such as summary plots, bar plots, or interaction plots to understand key feature behavior across the dataset.

In step 302, the multiple sets of SHAP values are aggregated to obtain a set of aggregated SHAP values. In one or more embodiments, aggregating the multiple sets of SHAP values comprises averaging the absolute SHAP values for each feature across all instances from the qualified ML models to determine the overall contribution of each feature. This process gives a global understanding of how strongly each feature influences predictions and creates a unified measure of feature importance. Further, the aggregation helps neutralize model specific biases and provides a more comprehensive view of feature importance by considering multiple ML models rather than relying on a single model's insight. After aggregating the SHAP values for all features across all of the qualified ML models, they are ranked based on importance.

In step 304, a static threshold is set. Further, in step 304, a high relative threshold is set based on the set of aggregated SHAP values. In one or more embodiments, the client(s) (100, FIG. 1) may set the static threshold and high relative threshold. The static threshold, which is a fixed value, is used to identify irrelevant features that are contributing negatively to the overall model performance and are flagged for removal. The high relative threshold is used to identify the most relevant features that may have been overlooked in the initial dataset. The static threshold adds a layer of certainty, ensuring that the truly irrelevant features (those with very low SHAP values) are removed in a consistent manner. In one or more embodiments, the static threshold and high relative threshold are dynamic thresholds, adjusting to the distribution of SHAP values for each specific dataset. In one or more embodiments, a low relative threshold may also be set to identify the least important features. This process helps in identifying which relevant features should be added to reduce the dimensionality of the dataset and focus on the most relevant features by discarding noise and less useful information.

In step 306, a first subset of aggregated SHAP values from the set of aggregated SHAP values that exceeds the high relative threshold is identified.

In step 308, a first set of features corresponding to the first subset of aggregated SHAP values is extracted to obtain a set of relevant features. In one or more embodiments, the first subset of aggregated SHAP values have relatively high SHAP values, in which the features corresponding to the first subset of aggregated SHAP values contribute positively to the model's overall performance and are considered significant.

In step 310, relevant features from the set of relevant features that are not present in the training dataset are added to the training dataset to obtain a fine-tuned training dataset. In one or more embodiments, the fine-tuned training dataset now has additional features that may have been overlooked initially, but are features that could have a potential significance in the overall model performance.

In step 312, a second subset of aggregated SHAP values from the set of aggregated SHAP values that fall below the static threshold are identified.

In step 314, a second set of features corresponding to the second subset of aggregated SHAP values is extracted to obtain a set of irrelevant features. In one or more embodiments, the second set of features contribute negatively to the model's overall performance and are considered noise.

In step 316, irrelevant features from the set of irrelevant features that are present in the fine-tuned training dataset are removed from the fine-tuned training dataset. In one or more embodiments, the fine-tuned training dataset is updated to remove any noise that may be contributing negatively to the model's overall performance.

The method may end following step 316.

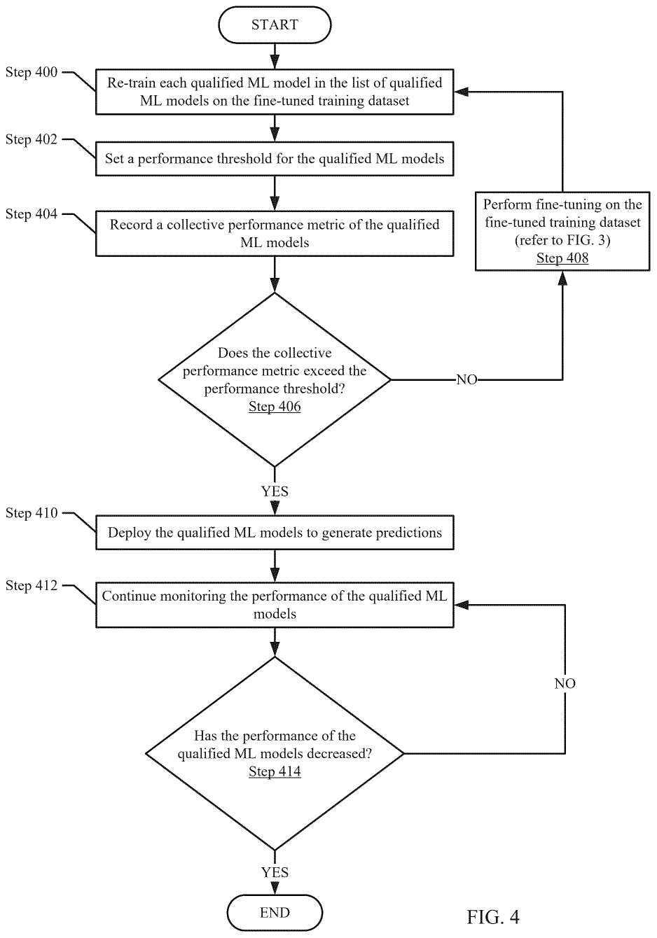

Turning to FIG. 4, FIG. 4 shows a flowchart of a method for monitoring the performance of the qualified ML models in accordance with one or more embodiments of the invention. The method may be performed by, for example, the dataset refining system (104, FIG. 1).

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 400, each qualified ML model in the list of qualified ML models is re-trained on the fine-tuned training dataset. In one or more embodiments, the qualified ML models are re-trained to ensure that the models learn from the updated training dataset (i.e., the fine-tuned training dataset).

In step 402, a performance threshold is set for the qualified ML models. In one or more embodiments, the client(s) (100, FIG. 1) may set the performance threshold.

In step 404, a collective performance metric of the qualified ML models is recorded. In one or more embodiments, the collective performance metric may include measuring the AUC or F1 metric of the qualified ML models.

In step 406, a determination is made as to whether the collective performance metric exceeds the performance threshold. Accordingly, in one or more embodiments, if the result of this determination is YES, the method proceeds to step 410. Alternatively, if the result of this determination is NO, the method proceeds to step 408.

In step 408, fine-tuning is performed on the fine-tuned training dataset. Details of the fine-tuning process are described in FIG. 3 above. In one or more embodiments, additional relevant features may be added to the fine-tuned training dataset, and additional irrelevant features may be removed from the fine-tuned training dataset, to obtain an updated fine-tuned training dataset. This process of the dataset refining system (104, FIG. 1) resembles an automated feedback loop to trigger subsequent retraining of the qualified ML models and refinement of the training dataset if necessary. After each ML model retraining, the feedback loop will automatically recalculate the SHAP values for the updated ML models. Further, the system will dynamically adjust the threshold for feature selection and feature dropping based on the SHAP value recalculations.

Further, in one or more embodiments, this process can be integrated into a Continuous Integration/Continuous Delivery (CI/CD) pipeline, ensuring that each time the ML models are retrained, SHAP analysis is automatically triggered, and the results are updated. The continuous integration ensures that model refinement remains up to date with each new iteration. Moreover, the automated process programmatically leverages SHAP value insights to make data-driven decisions in champion-challenger strategies. These decisions help facilitate the selection of the best models and iteratively refining the training dataset. The system continuously improves by integrating the SHAP value insights, minimizing the need for manual intervention in model selection and feature refinement. Once Step 408 is completed, the process proceeds to step 400.

If in Step 406 a determination is made as to whether the collective performance metric exceeds the performance threshold, then in step 410, the qualified ML models are deployed to generate predictions. In one or more embodiments, the predictions generated are based on the fine-tuned training dataset.

In step 412, the performance of the qualified ML models continues to be monitored. In one or more embodiments, Lasso (L1) regularization and/or Ridge (L2) regularization are used to monitor the performance of the qualified ML models. Moreover, multicollinearity checks are used to ensure that the fine-tuned training dataset contributes positively to the qualified models' performance without overfitting.

In step 414, a determination is made as to whether the performance of the qualified ML models has decreased. If the result of this determination is YES, the method may end following step 414 and the process may proceed back to FIG. 3. to start a new evaluation and new fine-tuning of the training data set. In one or more embodiments, if the performance of the qualified ML models has stabilized, the method may also end following step 414. This avoids over-refining or dropping critical features. Alternatively, if the result of this determination in step 414 is NO, the method proceeds back to step 412.

Embodiments of the disclosure may be implemented using computing devices. FIG. 5 shows a diagram of a computing device (500) in accordance with one or more embodiments. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (508) (e.g., Bluetooth interface, infrared interface, network interface, optical interface, etc.), input devices (512), output devices (510), and numerous other elements (not shown) and functionalities. Each of these components is described below.

In one embodiment, the computer processor(s) (502) may be an integrated circuit for processing instructions. For example, the computer processor(s) (502) may be one or more cores or micro-cores of a processor. The computing device (500) may also include one or more input devices (512), such as a touchscreen, keyboard, mouse, microphone, touchpad, electronic pen, or any other type of input device. The communication interface (508) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment, the computing device (500) may include one or more output devices (510), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (512, 510) may be locally or remotely connected to the computer processor(s) (502), nonpersistent storage (504), and persistent storage (506). Many diverse types of computing devices exist, and the aforementioned input and output device(s) (512, 510) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the invention, numerous specific details are set forth in order to provide a more thorough understanding of one or more embodiments of the invention. However, it will be apparent to one of ordinary skill in the art that the one or more embodiments of the invention may be practiced without these specific details. In other instances, well-known features have not been described in detail to avoid unnecessarily complicating the description.

In the prior description of the figures, any component described with regard to a figure, in various embodiments of the invention, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for fine-tuning a training dataset, the method comprising:
obtaining a set of machine learning (ML) models;
training, using a training dataset, each ML model in the set of ML models to obtain a set of trained ML models;
measuring, using a test dataset, a performance metric of each trained ML model in the set of trained ML models to obtain a set of performance metrics;
setting, based on the set of performance metrics, a performance threshold;
selecting the trained ML models with corresponding performance metrics that exceed the performance threshold to obtain a list of qualified ML models;
calculating a set of Shapley Additive Explanations (SHAP) values of each qualified ML model in a list of qualified ML models to obtain multiple sets of SHAP values;
aggregating the multiple sets of SHAP values to obtain a set of aggregated SHAP values;
setting a static threshold and setting, based on the set of aggregated SHAP values, a high relative threshold;
identifying a first subset of aggregated SHAP values from the set of aggregated SHAP values that exceed the high relative threshold;
extracting a first set of features corresponding to the first subset of aggregated SHAP values to obtain a set of relevant features;
adding, to the training dataset, relevant features from the set of relevant features that are not present in the training dataset to obtain a fine-tuned training dataset;
identifying a second subset of aggregated SHAP values from the set of aggregated SHAP values that fall below the static threshold;
extracting a second set of features corresponding to the second subset of aggregated SHAP values to obtain a set of irrelevant features;
removing, from the fine-tuned training dataset, irrelevant features from the set of irrelevant features that are present in the fine-tuned training dataset;
re-training, after the removing, each qualified ML model in the list of qualified ML models on the fine-tuned training dataset to obtain a set of re-trained qualified ML models;
setting a performance threshold for the re-trained qualified ML models;
recording a first collective performance metric of the re-trained qualified ML models;
making a first determination that the first collective performance metric exceeds the performance threshold;
deploying, based on the first determination, the re-trained qualified ML models to generate predictions; and
continuing to monitor a performance of the qualified ML models until the performance of the qualified ML models has stabilized, wherein the performance is based on an accuracy of the predictions.

2. The method of claim 1, wherein aggregating the multiple sets of SHAP values creates a unified measure of feature importance.

3. The method of claim 1, wherein continuing to monitor the performance of the qualified ML models is performed using multicollinearity.

4. The method of claim 1, the method further comprising:
after setting the performance threshold for the re-trained qualified ML models:
recording a second collective performance metric of the re-trained qualified ML models;
making a second determination that the second collective performance metric does not exceed the performance threshold; and
performing, based on the second determination, fine-tuning on the fine-tuned training dataset.

5. A method for fine-tuning a training dataset, the method comprising:
calculating a set of SHAP values of each qualified machine learning (ML) model in a list of qualified ML models to obtain multiple sets of SHAP values;
aggregating the multiple sets of SHAP values to obtain a set of aggregated SHAP values;
setting a static threshold and setting, based on the set of aggregated SHAP values, a high relative threshold;
identifying a first subset of aggregated SHAP values from the set of aggregated SHAP values that exceed the high relative threshold;
extracting a first set of features corresponding to the first subset of aggregated SHAP values to obtain a set of relevant features;
adding, to the training dataset, relevant features from the first set of relevant features that are not present in the training dataset to obtain a fine-tuned training dataset;
re-training each qualified ML model in the list of qualified ML models on the fine-tuned training dataset to obtain a set of re-trained qualified ML models;
setting a performance threshold for the re-trained qualified ML models;
recording a first collective performance metric of the re-trained qualified ML models;
making a first determination that the first collective performance metric exceeds the performance threshold;
deploying, based on the first determination, the re-trained qualified ML models to generate predictions; and
continuing to monitor a performance of the qualified ML models until the performance of the qualified ML models has stabilized, wherein the performance is based on an accuracy of the predictions.

6. The method of claim 5, wherein aggregating the multiple sets of SHAP values creates a unified measure of feature importance.

7. The method of claim 5, the method further comprising:
after adding to the training dataset, relevant features from the set of relevant features that are not present in the training dataset to obtain the fine-tuned training dataset:
identifying a second subset of aggregated SHAP values from the set of aggregated SHAP values that fall below the static threshold;
extracting a second set of features corresponding to the second subset of aggregated SHAP values to obtain a set of irrelevant features; and
removing, from the fine-tuned training dataset, irrelevant features from the set of irrelevant features that are present in the fine-tuned training dataset.

8. The method of claim 5, wherein continuing to monitor the performance of the qualified ML models is performed using multicollinearity.

9. The method of claim 5, the method further comprising:
after setting the performance threshold for the qualified ML models:
recording a second collective performance metric of the re-trained qualified ML models;
making a second determination that the second collective performance metric does not exceed the performance threshold; and
performing, based on the second determination, fine-tuning on the fine-tuned training dataset.

10. The method of claim 5, the method further comprising:
prior to calculating the set of SHAP values of each qualified ML model in the list of qualified ML models to obtain multiple sets of SHAP values:
obtaining a set of ML models;
training, using a training dataset, each ML model in the set of ML models to obtain a set of trained ML models;
measuring, using a test dataset, a performance metric of each trained ML model in the set of trained ML models to obtain a set of performance metrics;
setting, based on the set of performance metrics, a performance threshold; and
selecting the trained ML models with corresponding performance metrics that exceed the performance threshold to obtain the list of qualified ML models.

11. A method for fine-tuning a training dataset, the method comprising:
calculating a set of SHAP values of each qualified machine learning (ML) model in a list of qualified ML models to obtain multiple sets of SHAP values;
aggregating the multiple sets of SHAP values to obtain a set of aggregated SHAP values;
setting a static threshold and setting, based on the set of aggregated SHAP values, a high relative threshold;
identifying a first subset of aggregated SHAP values from the set of aggregated SHAP values that exceed the high relative threshold;
extracting a first set of features corresponding to the first subset of aggregated SHAP values to obtain a first set of relevant features; and
adding, to the training dataset, relevant features from the set of relevant features that are not present in the training dataset to obtain a fine-tuned training dataset.

12. The method of claim 11, the method further comprising:
identifying a second subset of aggregated SHAP values from the set of aggregated SHAP values that fall below the static threshold;
extracting a second set of features corresponding to the second subset of aggregated SHAP values to obtain a set of irrelevant features; and
removing, from the fine-tuned training dataset, irrelevant features from the set of irrelevant features that are present in the fine-tuned training dataset.

13. The method of claim 12, the method further comprising:
after removing, from the fine-tuned training dataset, irrelevant features from the set of irrelevant features that are present in the fine-tuned training dataset:
re-training each qualified ML model in the list of qualified ML models on the fine-tuned training dataset to obtain a set of re-trained qualified ML models; and
setting a performance threshold for the re-trained qualified ML models.

14. The method of claim 13, the method further comprising:
recording a first collective performance metric of the re-trained qualified ML models;
making a first determination that the first collective performance metric exceeds the performance threshold;
deploying, based on the first determination, the re-trained qualified ML models to generate predictions; and
continuing to monitor a performance of the qualified ML models until the performance of the qualified ML models has stabilized, wherein the performance is based on an accuracy of the predictions.

15. The method of claim 14, wherein continuing to monitor the performance of the qualified ML models is performed using multicollinearity.

16. The method of claim 13, the method further comprising:
recording a second collective performance metric of the re-trained qualified ML models;
making a second determination that the second collective performance metric does not exceed the performance threshold; and
performing, based on the second determination, fine-tuning on the fine-tuned training dataset.

17. The method of claim 16, wherein a Continuous Integration/Continuous Delivery (CI/CD) pipeline is used.

18. The method of claim 11, wherein aggregating the multiple sets of SHAP values creates a unified measure of feature importance.

19. The method of claim 11, the method further comprising:
prior to calculating the set of SHAP values of each qualified ML model in the list of qualified ML models to obtain multiple sets of SHAP values:
obtaining a set of ML models;
training, using a training dataset, each ML model in the set of ML models to obtain a set of trained ML models;
measuring, using a test dataset, a performance metric of each trained ML model in the set of trained ML models to obtain a set of performance metrics;
setting, based on the set of performance metrics, a performance threshold; and
selecting the trained ML models with corresponding performance metrics that exceed the performance threshold to obtain the list of qualified ML models.

20. The method of claim 19, wherein the set of ML models are obtained by a user.
